(19) United States
(12) Patent Application Publication
(10) Pub. No.: US 2005/0097211 A1
(43) Pub. Date: May 5, 2005

(54) Copyright protection

(76) Inventor: Jerry Petterson, Uppsala (SE)

Correspondence Address: NIXON & VANDERHYE, PC, 1100 N GLEBE ROAD, 8TH FLOOR, ARLINGTON, VA, 22201-4714, US

(21) Appl. No.: 10/677,749

(22) Filed: Oct. 3, 2003

(30) Foreign Application Priority Data
Oct. 1, 2003 (SE) 0302606-9

(51) Int. Cl. G06F 15/173; G06F 15/16

(52) U.S. Cl. 709/229; 709/223

(57) ABSTRACT

The invention relates to a method and a system for protection against piracy copying of recorded media (22). The media resides in storage means (18) in a network for data or telecommunication. By enhancing (26) the sound quality of the media (22) when played in end-user equipment (10), utilizing a specific identifier code, there is a positive protection against piracy copying.

### TECHNICAL FIELD

The present invention pertains to a method and a system for a positive protection against piracy copying of recorded media residing in storage means connected to a computer.

### BACKGROUND ART

The music and film industry is facing piracy copying, mostly over the Internet, of their copyright protected media. Hence, there are numerous of coding schemes to prevent copying of music on compact discs (CD) or film on video or digital video discs (DVD) bought in stores. But there always seems to be a skilled programmer that “cracks” the hidden codes, which should prevent piracy coping. Those cracks are almost immediately shared over the Internet.

Moreover, there is always a possibility that some persons employed in the music and film business are dishonest and for instance sell information about codes to outsiders.

Another approach to prevent piracy copying of media than to encode scrambled data on a CD or DVD discs is perhaps to come to an agreement between manufactures of end-user equipment, such as DVD-, CD-, MPEG-players, radio data systems (RDS) for cars, other car sound/audio equipment, home cinemas, PCs, and other known media end-user equipment, and the music distribution industry of a common system fighting piracy copying of digital media. To be able to accomplish such an agreement, there is a need for a versatile system that could easily be adopted by both parties, which has not yet occurred.

### SUMMARY OF THE DISCLOSED INVENTION

The present invention adheres somewhat in one embodiment to the approach of an agreement between manufactures and the music industry, but not necessarily. Another approach involves retailers selling music, film, speech and other reproducible sound/audio, to implement the method and system of the present invention. The present invention provides recorded media together with filter parameters enhancing the sound quality for specific sound reproduction equipment, thus there exists no incitement to copy the recorded media.

Hereby, the present invention sets forth a method for reducing the incitement for piracy copying of recorded media residing in storage means connected to a computer by enhancing the sound quality of the media when played in specific end-user equipment. Hence, the present invention comprises the steps of:
providing an end-user equipment with a specific identifier code utilized to provide the end user equipment with recorded media;
generating filter parameters in a sound processing engine corresponding to the specific identifier code and its related end-user equipment, the filter parameters enhancing the sound quality of the recorded media for the end-user equipment having the specific identifier code;
storing the filter parameters for every end-user equipment specific identifier cod in th storage means;
providing a site for purchase of recorded media, the purchase being initialized through at least the request of the end-user equipment identifier code;
filtering the purchased media through the stored filter parameters corresponding to the specific identifier code:
the filtering thus enhancing the sound quality of the purchased media to be played on the end-user equipment corresponding to the identifier code; and
delivering the filtered media.

An embodiment of the present invention comprises that the computer is a server in a network for data or telecommunication or a combination of both said networks.

In one embodiment of the present invention, the recorded media is music or film.

Another embodiment comprises that the manufacturer of the end-user equipment provides the equipment with the unique identifier.

A further embodiment comprises that the network site is provided by a music or film distributing company or retailer.

A still further embodiment provides that the filtering is combined with a Dirac Live™ or Pro™ or the like sound processing engine.

Yet another embodiment provides that the specific identifier code is a Media Access Control address (MAC-address).

Furthermore, the present invention sets forth a system for reducing piracy copying of recorded media. The media is residing in storage means. Reducing piracy copying is accomplished by enhancing the sound quality of the media when played in specific end-user equipment. The system comprises:
end-user equipment with a specific identifier code utilized to provide the end-user equipment with recorded media;
a sound processing engine generating filter parameters corresponding to the specific identifier code and its related end-user equipment, the filter parameters enhancing the sound quality of the recorded media for the end-user equipment having the specific identifier code;
storage means for storing the filter parameters for every end-user equipment specific identifier code;
a site for purchase of recorded media, the purchase being initialized through at least the request of the end-user equipment identifier code;
a filter, filtering the purchased media through the stored filter parameters corresponding to the specific identifier code, the filtering thus enhancing the sound quality of the purchased media to be played on the end-user equipment corresponding to the unique identifier code; and
delivering the filtered media.

The attached system sub-claims provide further embodiments of the present invention, which correspond to the attached set of method sub-claims.

### BRIEF DESCRIPTION OF THE DRAWINGS

Henceforth reference is had to the accompanying drawings for a better understanding of the embodiments and given examples of the present invention, in which:

FIG. 1 schematically illustrates one embodiment of a method and a system in an open network for reducing piracy copying of media in accordance with the present invention: and

FIG. 2 schematically illustrates one embodiment of a method and a system at a retailer premises for reducing piracy copying of media in accordance with the present invention.

### DETAILED DESCRIPTION OF PREFERRED EMBODIMENTS

The present invention provides a so called “positive” protection against piracy copying of media from the web such as Internet. By positive protection is meant that the sound quality is legally improved when utilizing the method and system of the present invention, i.e., piracy copying provides pour sound quality and the positive protection enhanced quality.

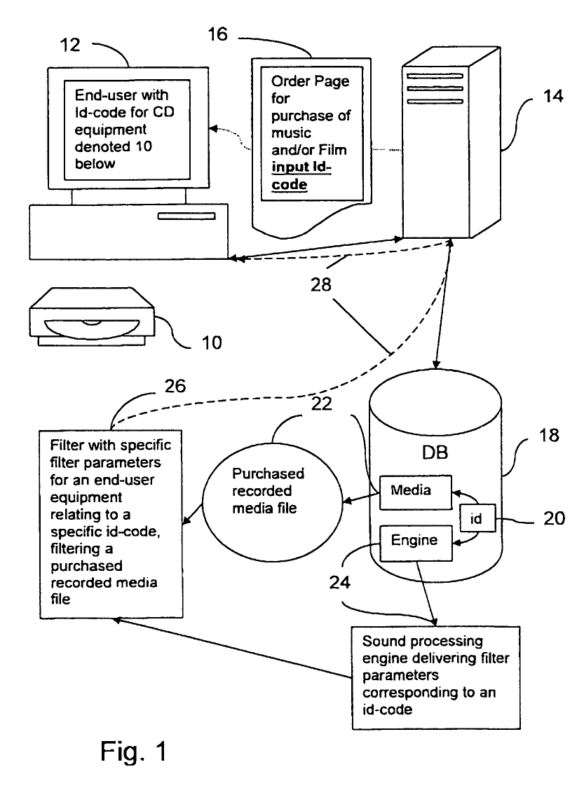

FIG. 1 is schematically illustrating one embodiment of a method and a system for preventing piracy copying of recorded media in accordance with the present invention. The expression recorded media refers to music, speech, video, movies, specifically all media including sound that can be reproduced. The system of the present invention as described in one embodiment comprises an end-user equipment 10, depicted as a CD-player in FIG. 1, but as mentioned any equipment that reproduces sound could be utilized, the CD-player 10, is utilized to exemplify one embodiment out of a plurality of such for different types of sound/audio reproducing equipment. When manufactured, the specific type of CD-player 10 receives an identify code (id-code) from the manufacturer, unique for that type of CD-player, or unique for every single CD-player or other music speech/film reproduction equipment as mentioned. An end-user purchasing a CD-player 10 receives the id-code for instance through the manual or a sealed envelope or the like.

Hence, FIG. 1 illustrates a system utilized in accordance with the present invention where an end-user equipment 10, here a CD-player which has being given an identifier code (id-code), for the sake of explanation, for example, the id-code A1234. The end-user that would like to purchase a music CD or DVD connects through his PC 12 to a music distributor's server 14 and the distributor's site/web/home page 16 pops up on the PC display screen.

Another viable code that could be utilized as the unique identifier code in a network as Internet is a Media Access Control address (MAC-address) for that sound or audio reproduction equipment having such an address.

It is appreciated that the method and the system of the present invention can be implemented with one or several computers in a dosed environment for instance in a store retailing recorded media or in an open environment such as depicted in FIG. 1.

The system in the embodiment of the present invention in accordance with FIG. 1 comprises that the computer connected to a storage means/database is a server 14 in a network for data or telecommunication or a combination of both the networks. It is understood by persons skilled in the art that there are hybrids of data and telecommunication systems such as for instance sending SMS-messages from a cellular phone to a PC, or e-mail from a PC to a cellular phone and numerous other hybrid functions.

The possible agreement between the manufacturer of media equipment and the distributor of recorded media such as music, speech or film, could be manifested through a storage/database 18 which is connected to or reachable from the server 14. Hence, when a purchaser buys a specific music, CD exemplified as media 22 in FIG. 1, from the distributor by adding the id-code A1234 on the order page 16, the music media 22 she/he bought is tied to the code A1234 of the music equipment 10 owned by the end-user through for instance an id-software means 20 connecting purchased media 22 with the code A1234 in the database 18. Simultaneously, the id-code is connected, through the id-software 20 to a sound processing engine 24, which delivers filter parameters that enhance the quality of the music played on the specific CD-player 10, having the id-code A1234. It should now be obvious to a person skilled in the art that an end-user during a purchase, or at another time, could provide more or multiple id-codes for different types of media sound reproducing equipment.

Such sound or audio processing engines, software, or machines can make a $200 CD-player 10 sound like a $1000 CD-player. The Swedish company Dirac research, currently residing in the city of Uppsala, are providing such sound processing. Products that can be provided by the company are, for example, Dirac Live™ and Dirac Live Pro™. Details of the sound processing parameters that they provide can be found at their web-page www.dirac.se.

Dirac Live™ technology provides a method to tailor and improve the entire sound image of a sound reproduction system according to any desired preference. Dirac Live™ perfects the transient and frequency characteristics of a sound reproduction system by minimizing all linear distorsions resulting from imperfect components in the sound chain. Dirac Live Pro™ enhances the capabilities of Dirac Live by allowing the emulation of any gain and/or transient response, thereby enabling precise tailoring of a system's sound character.

Other sound or audio processing engines for improvement of recorded media available to the public than the Dirac Live products could be also utilized.

Furthermore, with reference to FIG. 1, the sound processing engine 24 delivers filter parameters to a filter 26, filtering the purchased media 22. Those filter parameters are, through, for example, the Dirac sound processing, specifically designed to match equipment with id-code A1234. The purchased filtered 26 media 22 is for instance delivered 28 to the end-user's PC 12, where she/he can record a CD or DVD on the PC.

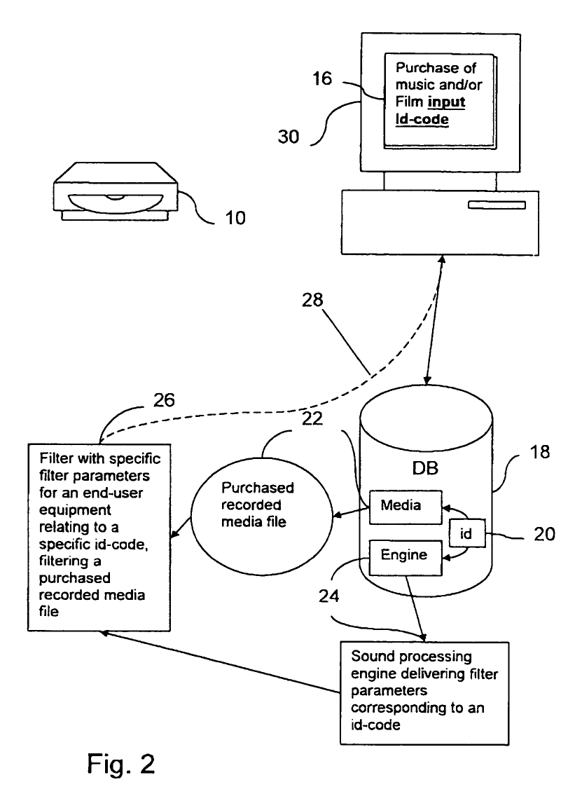

FIG. 2 schematically illustrates one embodiment of a method and a system at a retailer premises for reducing piracy copying of media in accordance with the present invention. The FIG. 2 differs from FIG. 1 in showing the method and system employed in for instance a store, department store, mall, supermarket or any kind of suitable retailer, which now, in this embodiment, are sites, selling audio, film, video or the like. Hence, a computer 30 is connected to a database 18, and when a costumer, for example, would like to by a music CD, as in the example above, but now in a shop, she/he gives their id-code, A1234, to the salesman and who types it on the computer display form 16 or the like, and the purchased CD is recorded with its filter parameters on a CD in a store, in the same manner as described in conjunction with FIG. 1. It is appreciated that a retailer either can be connected to the DB 18 through an open network such as Internet and/or having its own in-house network.

As the present invention provides recorded media 22 together with filter parameters enhancing the sound quality for specific sound reproduction equipment, there exists no incitement to copy the recorded media. A copy would not sound any good when played in the wrong equipment, i.e., equipment not having the same id-code.

The system and method of the present invention gives an end-user/media purchaser an incitement not to piracy copy freely distributed music or films via Internet, because the filtering has added a much better performance to here/his equipment 10. In one possible approach to accomplish the method and system of the present invention, manufacturers of media products such as CD-, MP3-, music-cassette-, DVD-players, hi-fi equipment, car sound or audio equipment, game consoles, loudspeakers, RDS equipment, home movie equipment and other like products for sound and/or audio reproduction could if they would come to an understanding with media producers/distributors unite to a standard or an agreement to introduce the invention herein described. This agreement should include that the music/film distributor and the manufacturer of equipment together utilize the provided id-code when music/film or other products including sound and/or audio are purchased by a costumer/consumer, herein named end-user.

Another possible approach to accomplish the method and system of the present invention is that the manufacturing companies of sound and/or audio reproducing equipment mark their different models with the id-code of the present invention, and that companies/stores that retail recorded media provide the sound processing engine utilized in the present invention and its parameters to their recorded media.

A still further approach would be that the company/store that retails recorded media provides both the id-code to the sound reproducing equipment and the filter parameters of the sound processing engine to the recorded media.

While the method and system described has been characterized in preferred embodiments and through examples it will be obvious for a person skilled in the art that the following claims define the scope of the invention.

1. A method reducing piracy copying of recorded media residing in storage means connected to a computer, by enhancing the sound quality of said media when played in specific end-user equipment, comprising the steps of:
providing an end-user equipment with a specific identifier code utilized to provide said end-user equipment with recorded media;
generating filter parameters in a sound processing engine corresponding to said specific identifier code and its related end-user equipment, said filter parameters enhancing the sound quality of the recorded media for the end-user equipment having said specific identifier code;
storing said filter parameters for every end-user equipment specific identifier code in said storage means;
providing a site for purchase of recorded media, said purchase being initialized through at least the request of said end-user equipment identifier code;
filtering said purchased media through the stored filter parameters corresponding to the specific identifier code;
said filtering thus enhancing the sound quality of the purchased media to be played on the end-user equipment corresponding to said specific identifier code; and
delivering said filtered media.

2. A method according to claim 1, wherein said computer is a server in a network for data or telecommunication or a combination of both said networks.

3. A method according to claim 1, wherein the recorded media is music or film.

4. A method according to claim 1, wherein the manufacturer of said end-user equipment provides the equipment with said identifier.

5. A method according to claim 1, wherein said site is a network site provided by a music or film distributing company or retailer.

6. A method according to claim 1, wherein the filter parameters are generated by a Dirac Live™ or Pro™ system or the like sound processing engine.

7. A method according to claim 1, wherein the specific identifier code is a Media Access Control address (MAC-address).

8. A system reducing piracy copying of recorded media residing in storage means connected to a computer, by enhancing the sound quality of said media when played in specific end-user equipment, comprising:
end-user equipment with a specific identifier code utilized to provide said end-user equipment with recorded media,
a sound processing engine generating filter parameters corresponding to said specific identifier code and its related end-user equipment, said filter parameters enhancing the sound quality of the recorded media for the end-user equipment having said specific identifier code;
storage means for storage of said filter parameters for every end-user equipment specific identifier code;
a site for purchase of recorded media, said purchase being initialized through at least the request of said end-user equipment identifier code;
a filter, filtering said purchased media through the stored filter parameters corresponding to the specific identifier code, said filtering thus enhancing the sound quality of the purchased media to be played on the end-user equipment corresponding to said unique identifier code; and
delivering said filtered media.

9. A system according to claim 8, wherein said computer is a server in a network for data or telecommunication or a combination of both said networks.

10. A system according to claim 8, wherein the recorded media is music, speech or film.

11. A system according to claim 8, wherein the manufacturer of said end-user equipment provides the equipment with said specific identifier.

12. A system according to claim 8, wherein said site is a network site provided by a music or film distributing company or retailer.

13. A system according to claim 8, wherein the filter parameters are generated by a Dirac Live™ or Pro™ or the like sound processing engine.

14. A system according to claim 8, wherein the unique identifier code is a Media Access Control address (MAC-address).
